(19) United States
(12) Patent Application Publication
(10) Pub. No.: US 2007/0009657 A1
(43) Pub. Date: Jan. 11, 2007

(54) Durable superhydrophobic coating

(75) Inventors: Hua Zhang, Sydney (AU); Robert Norman Lamb, Sydney (AU); Ashley Ward Jones, Sydney (AU)

Correspondence Address: FITCH EVEN TABIN AND FLANNERY, 120 SOUTH LA SALLE STREET, SUITE 1600, CHICAGO, IL, 60603-3406, US

(73) Assignee: New South Innovations Pty Limited, Sydney (AU)

(21) Appl. No.: 10/552,570

(22) PCT Filed: Apr. 8, 2004
(86) PCT No.: PCT/AU04/00462

§ 371 Date: Jun. 29, 2006

(30) Foreign Application Priority Data
Apr. 11, 2003 (AU) 2003901735

(51) Int. Cl. B05D 1/12

(52) U.S. Cl. 427/180; 427/487; 428/560; 428/206

(57) ABSTRACT

A method for forming a hydrophobic coating on the surface of a substrate comprising linking particulate material by polymer strands and cross-linking at least some of the polymer strands. The invention further relates to hydrophobic coatings comprising particles of a particulate material linked together and to a surface by polymer strands, wherein some of the polymer strands are cross-linked. The method of the invention can be used to form superhydrophobic coatings.

### TECHNICAL FIELD

This invention relates to the technology of coatings. In particular, the invention relates to a method for forming hydrophobic or superhydrophobic coatings on the surface of a substrate, and hydrophobic or superhydrophobic coatings prepared by the method.

### BACKGROUND ART

Wettability is an indicator of the affinity of a solid surface for a liquid. The wettability of a surface is dependent on both the physical and chemical heterogeneity of the surface.

The contact angle θ made by a droplet of liquid on the surface of a solid substrate has been used as a quantitative measure of the wettability of the surface. If the liquid spreads completely across the surface and forms a film, the contact angle θ is 0°. If there is any degree of beading of the liquid on the surface, the surface is considered to be non-wetting.

A surface is usually considered to be hydrophobic if the contact angle of a droplet of water is greater than 90°. Coatings on which water has a contact angle greater than 90° are referred to as hydrophobic coatings. Surfaces with water contact angles greater than 150° are commonly referred to as superhydrophobic. Similarly, coatings on which water has a contact angle greater than 150° are commonly referred to as superhydrophobic coatings.

Hydrophobic surfaces have little or no tendency to absorb water and water forms a discrete droplet on the surface. An example of a hydrophobic surface is a polytetrafluoroethylene (Teflon™) surface. Water contact angles on a polytetrafluoroethylene surface can reach about 115°. This is about the upper limit of hydrophobicity on smooth surfaces. The contact angle of a droplet of water on a surface can be increased, however, by causing the surface to become physically roughened.

If the surface is rough or heterogeneous there are usually two contact angles that can be measured. Tilting the surface until the droplet is about to roll off illustrates this phenomena The contact angle of the leading edge of the droplet represents the largest measurable contact angle and is called the advancing contact angle or θ_{adv}.

The contact angle of the receding edge of the droplet represents the minimum measurable contact angle and is called the receding contact angle or θ_{rec}. The difference between the advancing and receding contact angles is known as the contact angle hysteresis and defines the degree of dynamic wettability.

The contact angle hysteresis of water indicates the stability of a droplet of water on the surface; the lower the contact angle hysteresis the less stable the droplet is and therefore the easier the water droplet slides off the surface.

Hydrophobic coatings, and in particular superhydrophobic coatings, have many uses. Hydrophobic coatings are used to render surfaces water proof or water resistant. Superhydrophobic coatings have a “self-cleaning” property as dirt, bacteria, spores or other substances that come into contact with the surface cannot readily adhere to the coating and are readily washed off by water. Such coating are therefore used to render surfaces resistant to attachment by water soluble electrolytes, such as acids and alkalies, dirt and micro-organisms. Such coatings are also used to render surfaces resistant to icing and fouling.

Methods of forming superhydrophobic coatings, and applying superhydrophobic coatings to surfaces, have been described in the prior art. For example, WO 98/42452 and WO 01/14497 describe methods of forming superhydrophobic coatings. However, the superhydrophobic coatings formed by the methods described in WO 98/42452 and WO 01/14497 are generally easily damaged and removed from the surface to which they are applied. Such coatings therefore have a limited lifespan when exposed to an abrasive environment.

In view of the many practical uses of hydrophobic and superhydrophobic coatings, it would be advantageous to develop alternative methods for forming hydrophobic and superhydrophobic coatings on surfaces.

### SUMMARY OF THE INVENTION

In a first aspect, the present invention provides a method for forming a hydrophobic coating on the surface of a substrate, the method comprising the steps of:
(a) applying a mixture comprising a particulate material and a linking agent to the surface to form a coating on the surface, wherein the linking agent is capable of forming a polymer strand linking two or more particles of the particulate material and capable of forming a polymer strand linking the surface and one or more particles of the particulate material;
(b) exposing the coating to conditions such that the linking agent forms polymer strands linking two or more particles of the particulate material, and forms polymer strands linking the surface and one or more particles of the particulate material, thereby linking the particles together and to the surface by polymer strands; and
(c) exposing the coating to conditions effective to cause at least some of the polymer strands linking two or more particles or linking the surface and one or more particles, to cross-link with other polymer strands linking two or more particles or linking the surface and one or more particles.

Typically the contact angle of water on the coating formed by the method of the present invention is at least 150°. In some embodiments, the contact angle of water on the coating formed by the method of the present invention is at least 160°, and in some embodiments is at least 165°.

In the hydrophobic coatings formed by the method of the present invention, the particles of the particulate material are linked together and to the surface by polymer strands, and at least some of the polymer strands are cross-linked, thereby forming a three-dimensional network of cross-linked polymer strands. As a result of the cross-liking of the polymer strands, the hydrophobic coatings formed by the method of the present invention are typically more durable than coatings comprising particulate material linked by polymer strands that are not cross-linked. The present inventors have found that cross-linking the polymer strands enhances the durability of the coating. The method of the present invention can be used to form hydrophobic coatings that are more durable than the coatings described in WO 98/42452 or WO 01/14497.

The polymer strands linking two or more particles or linking the surface and one or more particles may be cross-linked by any means known in the art for cross-linking polymers. Preferred means are by a radical cross-linking reaction catalysed by peroxide, by a vinyl addition cross-linking reaction catalysed by a platinum catalyst, or by a condensation cross-lining reaction catalysed by a tin or zinc catalyst. In some embodiments of the invention, the mixture comprising the particulate material and the linking agent further comprises a polymer having terminal vinyl groups and a platinum catalyst to catalyse a vinyl addition reaction between the polymer having terminal vinyl groups and the polymer strands formed by the linking agent. The polymer having terminal vinyl groups may, for example, be selected from vinyl terminated polydimethylsiloxane, vinyl terminated diphenylsiloxane-dimethylsiloxane copolymer, vinyl terminated trifluoropropylmethylsiloxane-dimethylsiloxane copolymer and vinylmethyloxysiloxane homopolymer. The polymer strands may also be cross-linked by dehydrogenative coupling in which a hydrosilane group on one polymer strand reacts with a silanol group on another polymer strand.

Accordingly, in one embodiment, the present invention provides a method for forming a hydrophobic coating on the surface of a substrate, the method comprising the steps of:
(a) applying a mixture comprising a particulate material, a linking agent and a peroxide to the surface to form a coating on the surface, wherein the linking agent is capable of forming a polymer strand linking two or more particles of the particulate material and capable of forming a polymer strand linking the surface and one or more particles of the particulate material, and wherein the peroxide is capable of causing a peroxide catalysed cross-linking reaction between polymer strands formed by the linking agent;
(b) exposing the coating to conditions such that the linking agent forms polymer strands linking two or more particles of the particulate material, and forms polymer strands linking the surface and one or more particles of the particulate material, thereby linking the particles together and to the surface by polymer strands; and
(c) exposing the coating to conditions effective to cause a peroxide catalysed cross-linking reaction between at least some of the polymer strands linking two or more particles or linking the surface and one or more particles.

In another embodiment, the present invention provides a method for forming a hydrophobic coating on the surface of a substrate, the method comprising the steps of:
(a) applying a mixture comprising a particulate material, a linking agent and a platinum catalyst to the surface to form a coating on the surface, wherein the linking agent is capable of forming a polymer strand linking two or more particles of the particulate material and capable of forming a polymer strand linking the surface and one or more particles of the particulate material, and wherein the platinum catalyst is capable of catalysing a vinyl addition cross-linking reaction to cross-link polymer strands formed by the linking agent;
(b) exposing the coating to conditions such that the linking agent forms polymer strands linking two or more particles of the particulate material, and forms polymer strands linking the surface and one or more particles of the particulate material, thereby linking the particles together and to the surface by polymer strands; and
(c) exposing the coating to conditions effective to cause a platinum catalysed vinyl addition cross-linking reaction to cross-link at least some of the polymer strands linking two or more particles or linking the surface and one or more particles.

In some embodiments, the vinyl addition cross-linking reaction is a reaction between a vinyl group on one polymer strand and a suitable group on another polymer strand. In other embodiments, the mixture further comprises a cross-linking agent and the vinyl addition cross-linking reaction occurs between such groups on a polymer strand and the cross-linking agent, with concomitant or subsequent reactions with another polymer strand or cross-linking agent or agents forming a cross-link with another polymer strand. The cross-linking agent may for example be a polymer having terminal vinyl groups. Alternatively, if the polymer strands formed by the linking agent contain one or more vinyl groups, the cross-inking agent may for example be hydrosiloxane polymer.

Accordingly, in another embodiment, the present invention provides a method for forming a hydrophobic coating on the surface of a substrate, the method comprising the steps of:
(a) applying a mixture comprising a particulate material, a linking agent, a polymer having terminal vinyl groups and a platinum catalyst to the surface to form a coating on the surface, wherein the linking agent is capable of forming a polymer strand linking two or more particles of the particulate material and capable of forming a polymer strand linking the surface and one or more particles of the particulate material, and wherein the platinum catalyst is capable of catalysing a vinyl addition reaction between the polymer having terminal vinyl groups and polymer strands formed by the linking agent;
(b) exposing the coating to conditions such that the linking agent forms polymer strands linking two or more particles of the particulate material, and forms polymer strands linking the surface and one or more particles of the particulate material, thereby linking the particles together and to the surface by polymer strands; and
(c) exposing the coating to conditions effective to cause a vinyl addition reaction between the polymer having terminal vinyl groups and at least some of the polymer strands linking two or more particles or linking the surface and one or more particles.

In yet another embodiment, the present invention provides a method for forming a hydrophobic coating on the surface of a substrate, the method comprising the steps of:
(a) applying a mixture comprising a particulate material, a linking agent, and a tin or zinc catalyst to the surface to form a coating on the surface, wherein the linking agent is capable of forming a polymer strand linking two or more particles of the particulate material and capable of forming a polymer strand linking the surface and one or more particles of the particulate material, and wherein the catalyst is capable of catalysing a condensation cross-linking reaction to cross-link polymer strands formed by the linking agent;
(b) exposing the coating to conditions such that the linking agent forms polymer strands linking two or more particles of the particulate material, and forms polymer strands linking the surface and one or more particles of the particulate material, thereby linking the particles together and to the surface by polymer strands; and
(c) exposing the coating to conditions effective to cause a condensation cross-linking reaction to cross-link at least some of the polymer strands linking two or more particles or linking the surface and one or more particles.

In some embodiments, the condensation cross-linking reaction is a reaction between an alkoxysilane group on one polymer strand and a hydrosilane group on another polymer strand, thus cross-linking the two polymer strands. Alternatively, the condensation cross-linking reaction may be between such groups on a polymer strand and a cross-linking agent, with concomitant or subsequent reactions with another polymer strand or cross-linking agent or agents forming a cross-link with another polymer strand.

In a second aspect, the present invention provides a hydrophobic coating formed by the method according to the first aspect of the present invention.

In a third aspect, the present invention provides an object having a surface at least a portion of which is coated with a hydrophobic coating formed by the method according to the first aspect of the present invention.

In a fourth aspect, the present invention provides a hydrophobic coating comprising particulate material bound together and to the surface by polymer strands, wherein at least some of the polymer strands are cross-linked.

### DETAILED DESCRIPTION OF THE INVENTION

Particulate Material

The particulate material may consist of particles having substantially equal diameters, or alternatively particles having a spectrum of diameters. Preferably, at least some of the particles have diameters within the range of from 1 nm to 500 μm. More preferably, all or substantially all of the particles have diameters in the range of from 1 nm to 500 μn, more preferably, in the range from 1 nm to 100 μm, still more preferably, in the range of from 1 nm to 1 μm, still more preferably, in the range of from 1 nm to 100 nm, and even more preferably in the range of from 5 nm to 50 nm.

In one embodiment, the particulate material consists of particles having an average particle size (diameter) in the range of from 1 nm to 500 μm. In a further embodiment, the average particle size is in the range of from 5 nm to 50 nm. In yet a further embodiment, the average particle size is in the range of from 5 nm to 20 nm. In yet a further embodiment, the average particle size is about 15 nm.

In a preferred embodiment of the present invention, the particulate material consists of silica particles, such as flame-hydrolysed silica particles. However, other particulate material comprising particles of an appropriate size could be used. Other particulate materials which could be used include particles of cementitious material such as Portland cement and gypsum, metal particles, glass particles and particles of metal oxides, such as titanium oxide, aluminium oxide, zirconium oxide and zinc oxide.

The particulate material may comprise a mixture of two or more types of particles. For example, the particulate material may comprise a mixture of silica particles and particles of a metal oxide, or a mixture of cement particles and particles of a metal oxide.

Chemical Modifying Reagent

In some embodiments, the particles of the particulate material are modified by contact with a chemical modifying reagent capable of reacting with the particles to enhance the chemical hydrophobicity of the particles, and thus the hydrophobicity of the coating formed by the method of the present invention.

Typically, the chemical hydrophobicity of the particles is enhanced by the chemical modifying reagent reacting with a hydrophilic group on the surface of the particles to remove the hydrophilic group or to convert the hydrophilic group to a hydrophobic group. The chemical modifying reagent may also react with the surface of the particles to form functional groups on the surface of the particles that facilitate binding of the particles to the linking agent in step (b) of the method of the present invention.

The particulate material may be contacted with the chemical modifying reagent prior to formation of the mixture comprising the particulate material and the ling agent. Alternatively, the chemical modifying reagent may be included in the mixture comprising the particulate material and the ling agent applied to the surface in step (a) of the method of the present invention. Accordingly, in some embodiments of the present invention, the mixture applied to the surface in step (a) further comprises a chemical modifying reagent capable of reacting with at least some of the particles of the particulate material to enhance the chemical hydrophobicity of the particles. In such an embodiment of the present invention, the chemical modifying reagent may also enhance the cross-linking of the polymer strands in step (c) by reacting with the polymer strands formed by the linking agent and providing additional cross-linking sites. Furthermore, in some embodiments, the chemical modifying reagent may react with the polymer strands formed by the linking agent to cross-link the polymer strands, that is, the chemical modifying agent may also act as a cross-linking agent.

The chemical modifying reagent may be a compound containing one or more condensation cure groups and one or more hydrophobic groups. The one or more condensation cure groups may include one or more of the following groups: acetoxy, enoxy, oxirne, alkoxyl, or amine. Such chemical modifying reagents include compounds of the formula SiR¹(OR²)₃, where R¹ is a hydrophobic group such as alkyl (eg methyl or ethyl), vinyl, epoxyalkyl, methacrylate or perfluoroalkyl (eg trifluoropropyl), and each R² is independently selected and is methyl, ethyl or acetyl.

The same compound may act as both a linking agent and a chemical modifying reagent. Alternatively, different compounds may be used as the linking agent and the chemical modifying reagent.

Linking Agent

The liking agent may be any compound or mixture of compounds capable of forming a polymer strand linking two or more particles of the particulate material and capable of forming a polymer strand linking the surface and one or more particles of the particulate material.

In some embodiments, the linking agent is a polymer or mixture of polymers capable of reacting with two or more particles of the particulate material thereby linking the particles by a polymer strand covalently bound to the particles, and capable of reacting with the surface and one or more particles of the particulate material thereby linking the surface and the one or more particles by a polymer strand covalently bound to the particles and to the surface.

When the particles of the particulate material have hydroxyl groups on the surface of the particles, suitable polymers include siloxane polymers. Such polymers are capable of binding to hydroxyl groups on the surface of the particles via a condensation reaction. This reaction can also render the surface of the particle chemically hydrophobic. For example, when the particulate material is flame-hydrolysed silica particles, the siloxane polymers are capable of binding to hydroxyl groups on the surface of the silica particles, thereby changing the hydrophilic silanol group (≡Si—OH) to a hydrophobic siloxane group (≡Si—O—Si≡).

Suitable siloxane polymers include hydroxy terminated vinylsiloxane polymer, hydroxy terminated polydiinethylsiloxane (PDMS), hydroxy terminated polydiphenylsiloicane, hydroxy terminated polyphenylmethylsiloxane, methylhydrosiloxane (and copolymers with dimethylsiloxane), vinylmethoxysiloxane homopolymer, polytrifiuoropropylmethylsiloxane (silanol terminated), vinylmethylsiloxane-dimethylsiloxane copolymer (silanol terminated) and vinylmethylsiloxanes, or metal alkoxide silanes such as methyltrialkoxysilanes, ethyltrialkoxysilanes, vinyltrialkoxysilanes, epoxyl trimethoxysilanes, methacrylate trimethoxysilanes and perfluorotrialkoxysilanes. The invention is not limited, however, to methods involving the use of siloxane polymers. Other polymers that can be used which do not contain silica include modified polystyrene, polyethylenes and fluorinated polymers. Suitable polymers also include triethoxysilyl modified poly-1,2-butadiene and polyethylene-co-trialkoxyvinylsilane.

In some embodiments of the present invention, the linking agent is a monomer or mixture of monomers capable of reacting with the particles of the particulate material and the surface, capable of reacting to form a polymer strand linking two or more particles of the particulate material, and capable of reacting to form a polymer strand linking the surface and one or more particles of the particulate material. Such a liking agent reacts to link the two or more particles by a polymer strand covalently bound to the particles, and reacts to link the surface and the one or more particles by a polymer strand covalently bound to the surface and to the one or more particles. Such linking agents may for example, be a bifunctional or trifunctional alkylsilane. The lining agent may for example be a compound of the formula SiR¹R²(R³)₂ where R¹ is alkyl, R² is alkyl, hydrogen, methoxy or ethoxy, and each R³ is independently selected and is methoxy, ethoxy, hydroxy or vinyl alkoxy. Suitable linking agents include methyltrimethyoxysilane, vinyltrimethylsilane, methyltris(methylethylketoximno)silane, methyltriacetoxysilane, ethyltriacetoxysilane or vinyltriacetoxysilane.

Mixture

The mixture comprising the particulate material and the linking agent may include other components.

For example, the mixture may include a chemical modifying reagent as described above. The mixture typically also includes a solvent, preferably an organic solvent, for example, hexane, heptane, ethyl acetate, butyl acetate, toluene, xylene, methylethyl ketone or diethyl ether.

The mixture may also include components for catalysing the cross-linkig of the polymer strands formed by the linking agent. For example, the mixture may include a peroxide to catalyse a peroxide catalysed cross-linking reaction between polymer strands formed by the linking agent. Similarly, the mixture may include a platinum catalyst for catalysing a vinyl addition cross-linking reaction, or a tin or zinc catalyst for catalysing a condensation cross-linking reaction.

In some embodiments of the invention, the mixture further comprises one or more cross-linking agents to form a cross-link between the polymer strands formed by the linking-agent. In those embodiments where the polymer strands are cross-linked in step (c) of the method of the present invention by a platinum catalysed vinyl addition cross-linking reaction, the cross-linking agent may for example be a polymer having terminal vinyl groups. Polymers have terminal vinyl groups are capable of reacting with other polymers to cross-link the polymers by a vinyl addition cross-linling reaction catalysed by a platinum catalyst. In those embodiments where the polymer strands are cross-linked in step (c) of the method by a condensation cross-linking reaction catalysed by a tin or zinc catalyst, suitable cross-linking agents are trifunctional alkylsilanes, typically trialkoxysilanes such as methyltrimethoxysilane.

In step (a) of the method of the present invention, the mixture may be applied to the surface of the substrate by separately applying the components of the mixture to the surface and mixing the components on the surface. However, more typically, the mixture comprising the particulate material and the linking agent is first prepared and the mixture then applied to the surface.

The mixture comprising the particulate material and the linking agent may be prepared by mixing the particulate material, the linking agent, and the other components of the mixture, if any, in an ultrasonic bath. The mixture is typically applied to the surface as a slurry or a paste. This can be achieved by including one or more solvents, preferably organic solvents, in the mixture. One solvent found to be particularly suitable when the particulate material comprises silica particles is hexane, however, other solvents could be used, for example diethyl ether.

The mixture may be applied to the surface by any technique suitable for forming a coating on the surface of the substrate. One technique is to paint the mixture onto the surface. A second technique is dip coating. In this technique, the substrate is immersed in the mixture and withdrawn at a particular rate. A third technique is spin coating. In this technique, the substrate is attached to a horizontal platform capable of spinning at a high rate, such as a few thousand rpm. The mixture is deposited drop-wise onto the surface of the substrate whilst it is spinning, which results in a highly uniform coating on the surface of the substrate. The coating thickness can be controlled by adjusting the spin rate or the volume of mixture deposited. A further coating technique is spray coating. In this technique, a spray solution of the mixture is sprayed onto the surface of the substrate at an appropriate distance, flow rate and length of time such that a uniform coating of adequate thickness is formed.

In some embodiments of the present invention, after the mixture has been applied to the surface, the mixture may be treated to remove solvent(s) from the mixture. This treatment may include heating the applied mixture to a temperature effective to evaporate the solvent(s), but which does not exceed the melting point of the substrate or any components of the mixture (other than the solvent(s)), or exceed the temperature at which the substrate or any of the components of the mixture (other than the solvent(s)) decomposes. The drying time will depend on a number of factors such as the thickness of the mixture applied to the surface and the components of the mixture. Vacuum drying, or a combination of vacuum drying and heating, may be used if the substrate has a low melting point.

Steps (b) and (c)

Step (b) of the method of the present invention comprises exposing the coating to conditions effective for the linking agent to form polymer strands linking two or more particles of the particulate material, and to form polymer strands linking the surface and one or more particles of the particulate material, thereby linking the particles together and to the surface by polymer strands. The conditions will vary depending on the particulate material and the linking agent used.

In some embodiments of the present invention, the linking agent may form polymer strands linking two or more particles of the particulate material, and form polymer strands linking the surface and one or more particles of the particulate material, at ambient temperatures (i.e room temperature, for example at about 15 to 25° C.). In such a case, step (b) typically comprises exposing the coating to ambient temperatures for a period of time sufficient for the linking agent to form polymer strands linking two or more particles of the particulate material, and to form polymer strands linking the surface and one or more particles of the particulate material, thereby linking the particles together and to the surface by polymer strands.

When a monomer such as methyltriacetoxysilane is used as the linking agent, step (b) typically comprises heating the coating to a temperature and for a time effective for the linking agent to form polymer strands linking two or more particles of the particulate material, and to form polymer strands linking the surface and one or more particles of the particulate material, thereby linking the particles together and to the surface by polymer strands.

Step (c) of the method of the present invention comprises exposing the coating to conditions effective to cause at least some of the polymer strands linking two or more particles of the particulate material or linking the surface and one or more particles of the particulate material, to cross-link with other polymer strands linking two or more particles or linking the surface and one or more particles.

The polymer strands may be cross-linked by any means known in the art for cross-linking polymers. Preferred means are by a radical cross-liking reaction catalysed by peroxide, by a vinyl addition cross-linking reaction catalysed by a platinum catalyst, or by a condensation cross-linking reaction catalysed by a tin or zinc catalyst. The polymer strands may also be cross-linked by dehydrogenative coupling, in which a hydrosilane group on one polymer strand reacts with a silanol group on another polymer strand.

The conditions of step (c) of the method of the present invention will vary depending on the particulate material and the linking agent used and the reaction used to cross-link the polymer strands. The appropriate conditions may be readily determined by a person skilled in the art.

As mentioned above, in some embodiments of the present invention, the polymer strands are cross-linked by a radical cross-linking reaction catalysed by peroxide. The radical cross-linking reaction catalysed by peroxide typically involves the radical addition of a vinyl group with a methyl or methylene group to form a covalent bond. The reaction may be between a vinyl group on one polymer strand and a methyl or methylene group on another polymer strand, thereby cross-linking the polymer strands. Alternatively, the reaction may be between such groups on a polymer strand and a cross-liking agent, with concomitant or subsequent reactions with another polymer strand or cross-linking agent or agents forming a cross-link with another polymer strand. In some cases, a cross-lining reaction may occur even if no vinyl groups are present, provided a large amount of peroxide is used. The peroxide may be any peroxide capable of catalysing the cross-linking reaction, for example, dicumyl peroxide, 2,4-dichlorobenzoyl peroxide, or benzoyl peroxide, or a mixture thereof. The radical cross-linking reaction catalysed by peroxide typically occurs at a temperature of about 100 to about 150° C. in a time of about 10 to about 180 minutes. Accordingly, in those embodiments of the present invention where the polymer strands are cross-linked by a radical cross-linking reaction catalysed by peroxide, step (c) typically comprises heating the coating to a temperature of from about 100° C. to about 150° C. for a period of time effective to cause at least some of the polymer strands to become cross-linked.

In some embodiments of the present invention, the polymer strands are cross-linked by a vinyl addition cross-linking reaction in the presence of a platinum catalyst to catalyse the reaction. The reaction may for example be between a vinyl group on one polymer strand and a hydrosilane group on another polymer strand, thereby cross-linking the polymer strands. Alternatively, the reaction may be between such groups on a polymer strand and a cross-linking agent, with concomitant or subsequent reactions with another polymer strand or cross-linking agent or agents forming a cross-link with another polymer strand. The cross-linking agent may for example be a polymer having terminal vinyl groups. Suitable platinum catalysts include platinum divinyl complexes or platinum cyclovinyl complexes. Such reactions can be carried out at room temperatures (e.g. at about 15 to 25° C.) or heat cured at up to about 150° C. Accordingly, in those embodiments of the invention where the polymer strands are cross-linked by a vinyl addition cross-linking reaction in the presence of a platinum catalyst, step (c) typically involves exposing the coating to a temperature of about 150° C. for a period of time effective to cause at least some of the polymer strands to become cross-linked.

In other embodiments of the present invention, the polymer strands are cross-linked by a condensation cross-linking reaction in the presence of a tin or zinc catalyst. The condensation reaction may for example be between an alkoxysilane group on one polymer strand and a hydrosilane group on another polymer strand, which results in the formation of a Si—O—Si bond between the polymer strands. Alternatively, the reaction may be between such groups on a polymer strand and a cross-linking agent, with concomitant or subsequent reactions with another polymer strand or cross-linking agent or agents forming a cross-link with another polymer strand. Suitable catalysts include dibutyltin dilaurate or zinc octoate. Such reactions can be carried out at room temperatures (e.g. at about 15 to 25° C.) or heat cured at up to about 150° C. Accordingly, in those embodiments of the invention where the polymer strands are cross-linked by a condensation cross-linking reaction in the presence of a tin or zinc catalyst, step (c) typically comprises exposing the coating to ambient temperatures or heating the coating to a temperature of about 150° C. for a period of time effective to cause at least some of the polymer strands to become cross-linked.

In some embodiments of the present invention, step (b) is carried out prior to step (c). In other embodiments of the present invention, steps (b) and (c) are carried out simultaneously.

The coatings formed by the method of the present invention comprise the particles of the particulate material linked by polymer strands. The hydrophobicity of the coatings formed by the method of the present invention is due to a combination of both the intrinsic chemical hydrophobicity of the surface of the coating and the physical surface structure of the surface of the coating. Accordingly, during the method of the present invention, the particles of the particulate material, if not initially chemically hydrophobic, preferably become chemically hydrophobic. The particles of the particulate material may become chemically hydrophobic as a result of hydrophilic groups on the particles reacting with the linking agent, or reacting with a chemical modifying reagent. Similarly, it is preferred that the linking agent forms polymer strands which are chemically hydrophobic.

In order that the present invention may be more clearly understood, the invention will now be described with reference to certain preferred embodiments.

In a preferred embodiment, the particulate material is silica particles and the linking agent is a siloxane polymer, such as hydroxy terminated PDMS, or a monomer such as methyltriacetoxysilane. Suitable silica particles include commercially available flame-hydrolysed silica powder, available as Aerosil™ silica powder from Degussa Limited, with particles having a primary size in the range of 5 to 50 nm. Flame-hydrolysed silica particles are hydrophilic, as the surface of the particles contains the hydrophilic silanol functional group (≡Si—OH). However, the surface chemistry of the particles is changed during the method of the invention, as the silanol functional groups (≡Si—OH) are converted to the hydrophobic siloxane finctional groups (≡Si—O—Si≡) through reactions with the linking agent or a chemical modifying reagent.

It is preferred to modify the silica particles by contacting the silica particles with a chemical modifying reagent such as a compound of the formula SiR¹(OR²)₃, where R¹ is a hydrophobic group such as alkyl (eg methyl or ethyl), vinyl, epoxyalkyl, methacrylate or perfluoroalkyl (eg trifluoropropyl), and each R² is independently selected and is methyl, ethyl or acetyl. Typically, the silica particles are contacted with the chemical modifying agent by including the chemical modifying reagent in the mixture comprising the particulate material and the linking agent applied to the surface in step (a) of the method of the present invention.

Hydroxy terminated PDMS is a preferred linking agent because it is unusually resistant to heat, being able to withstand temperatures up to about 400° C. without deformation. It also has high electrical resistance, and is able to withstand outdoor exposure to UV radiation with little or no deformation or degradation for at least 10 years. PDMS is terminated with hydroxyl groups which function as sites where the PDMS molecules are able to react with and bond to two silica particles or to the surface and a silica particle. The PDMS becomes chemically hydrophobic when the hydroxyl groups are removed by reaction with the silica particles.

In some preferred embodiments of the present invention, the particulate material is silica particles, the linking agent is hydroxy terminated PDMS and the chemical modifying reagent is a compound of the formula SiR(OAc)₃, where R is a hydrophobic group. In such an embodiment of the present invention, the primary reactions which occur between the silica particles, the lining agent, and the chemical modifying reagent are set out below:
1) condensation reaction between the silica particles and the chemical modifying reagent: 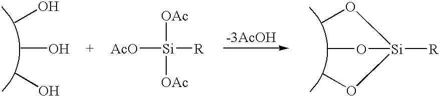
   Colloidal silica
2) reaction between PDMS and the chemical modifying reagent: 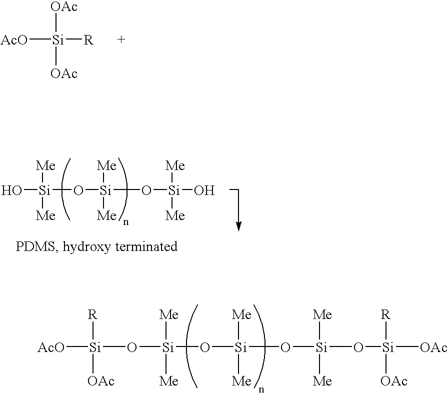
3) reaction between PDMS and the silica particles: 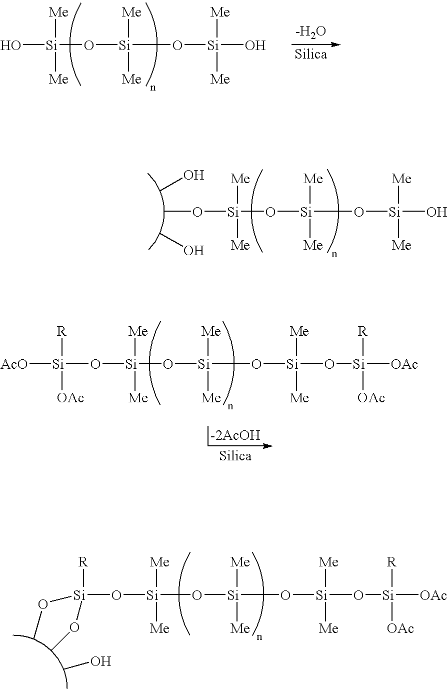
   In some embodiments of the present invention, the polymer strands formed by the linking agent contain vinyl groups. Such polymer strands can be cross-linked via a peroxide induced radical cross-linking reaction between vinyl and methyl groups on adjacent polymer strands. Concomitant and subsequent reactions take place among methyl groups and between cross-link sites and vinyl groups. The initial cross-linking reaction for vinylmethylsiloxane copolymers is as follows: 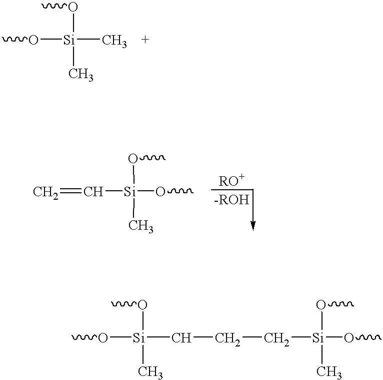
   where indicates [symbol] indicates a polymer chain.

A cross-linking reaction may occur even if no polymer strands have vinyl groups, provided a large amount of peroxide is present. In such a case, an example of the reaction which causes cross-linking is as follows:

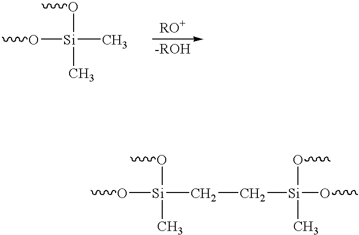

In some embodiments of the invention, the polymer strands formed by the linking agent are cross-linked by a vinyl addition reaction with a polymer having terminal vinyl groups catalysed by a platinum catalyst. An example of such a reaction is as follows: 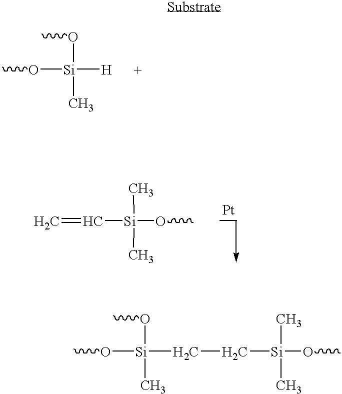
The types of substrate to which the hydrophobic or superhydrophobic coatings of the invention may be applied include for example, glass, metals such as aluminium or steel, metal oxides, rubber, ceramics, concrete, fibre cement, and wood.

The invention is described in more detail below by reference to certain non-limiting examples. It will be appreciated by persons skilled in the art that numerous variations and/or modifications maybe made to the invention as shown in the examples without departing from the sprit or scope of the invention as broadly described. The examples are, therefore, to be considered in all respects as illustrative and not restrictive.

### EXAMPLES

In Examples 1 to 5 described below, the particulate material used was flame-hydrolysed silica powder having a primary particle size of 5 to 50 nm. The flame-hydrolysed silica powder used is Aerosil™ silica. The specific surface area of Aerosil™ silica is about 50-600 m²/g. The large specific surface area represents an important characteristic of Aerosil™ silica. Since the specific surface area of the Aerosil™ silica is large in relation to the mass, the surface chemistry plays a significant role and influences the surface properties of the coating formed using such particles.

In the following examples, the contact angle and the hysteresis of water on the coated surfaces were determined by an automated contact angle instrument goniometer (made by Ramé-hart, Inc). The uncertainty in the measurements of the contact angle is ±5°.

In the following examples, the hardness and adhesion of the coated surfaces were determined as follows:
(a) Hardness: Coating hardness was estimated by a pencil hardness test according to ASTM D3363-92a (“Standard test method for film hardness by pencil test”), in which 9H is the hardest pencil, indicating the hardest coating, and 9B is the softest pencil, indicating the softest coating. 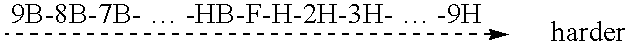
(b) Adhesion: Coating adhesion was estimated by a tape test according to ASTM D3359-97 (“Standard test methods for measuring adhesion by tape test”), in which 0A indicates the poorest adhesion performance and 5A the strongest adhesion.

### Comparative Example

A hydrophobic coating was applied to the surface of a glass substrate and a rubber substrate as described below.

The following were mixed together:

| | |
|---|---|
| 0.4 g PDMS (hydroxy terminated) | CAS [70131-67-8] |
| 0.3 g methyltriacetoxysilane | CAS [4253-34-3] |
| 0.1 g Aerosil silica powder, and | |
| ˜20 ml hexane | |

The mixture was mixed well and vibrated in an ultrasonic bath for 15 to 30 minutes to disperse the particles and form a uniform mixture. Vibration frequencies of about 40 kHz were used.
The mixture was removed from the ultrasonic bath.
Without allowing the mixture to settle, the mixture was deposited onto the surface of the substrate by spray coating. Other techniques such as spin coating or dip coating could have been used.
The coated substrate was placed in an oven at a temperature of about 150° C. for 10 to 30 minutes. The coated substrate could alternatively have been cured at room temperature.

The contact angle and hysteresis of water on the coated surfaces, the adhesion of the coatings, and the hardness of the coating on the glass substrate, were:

Glass substrate
Contact angle: 154°
Hysteresis: 75°
Gouge Hardness: 2B
Scratch Hardness: 8B
Adhesion: 5A

Rubber Substrate
Contact angle: 155°
Hysteresis: 31°
Adhesion: 5A

### Example 1

In this example, a hydrophobic coating was formed on the surface of a glass and rubber substrate using a method similar to that in the above Comparative Example, except that the polymer strands formed by the linking agent (hydroxy terminated PDMS) were cross-linked via a free radical cross-linking reaction. The cross-linking reaction was catalysed by the presence of a large amount of peroxide.

The coatings were applied as follows:

The following were mixed together:

| | |
|---|---|
| 0.4 g PDMS (hydroxy terminated) | CAS [70131-67-8] |
| 0.3 g methyltriacetoxysilane | CAS [4253-34-3] |
| 0.1 g dicumyl peroxide | CAS [80-43-3] |
| 0.1 g Aerosil silica powder, and | |
| ˜20 ml hexane | |

The mixture was mixed well and vibrated in an ultrasonic bath for 15 to 30 minutes to disperse the particles and form a uniform mixture. Vibration frequencies of about 40 kHz were used.
The mixture was removed from the ultrasonic bath.
Without allowing the mixture to settle, drops of the mixture were deposited on the surface of the substrate by spray coating.
The coated substrate was placed in oven at a temperature of about 150° C. for 30-60 minutes.

The contact angle and hysteresis of water on the coated surfaces, the adhesion of the coatings, and the hardness of the coating on the glass substrate, were:

Glass
Contact angle: 166°
Hysteresis: 19°
Gouge Hardness: HB
Scratch Hardness: 7B
Adhesion: 5A

Rubber
Contact angle: 166°
Hysteresis: 55°
Adhesion: 5A

### Example 2

In this example, a hydrophobic coating was formed on the surface of a glass substrate and a rubber substrate as described below. In this example, the linking agent was vinylsiloxane polymer (hydroxy terminated). This polymer includes vinyl groups which are able to react with methyl groups on the polymer strands formed by the linking agent via a free radical cross-linking reaction using a catalytic amount of peroxide.

The following were mixed together:

| | |
|---|---|
| 0.50 g vinylsiloxane polymer (hydroxy terminated) | CAS [67923-19-7] |
| 0.36 g methyltriacetoxysilane | CAS [4253-34-3] |
| 0.03 g dicumyl peroxide | CAS [80-43-3] |
| 0.12 g Aerosil silica powder, and | |
| ˜25 ml hexane | |

The mixture was mixed well and vibrated in an ultrasonic bath for 15 to 30 minutes to disperse the particles and form a uniform mixture. Vibration frequencies of about 40 kHz were used.
The mixture was removed from the ultrasonic bath.
Without allowing the mixture to settle, drops of the mixture were deposited onto the surface of the substrate by spray coating.
The coated substrate was placed in oven at a temperature of about 150° C. for 30-60 minutes. The coated substrate alternatively could have been cured at room temperature if desired.

The contact angle and hysteresis of water on the coated surfaces, the adhesion of the coatings, and the hardness of the coating on the glass substrate, were:

Glass
Contact angle: 166°
Hysteresis: 9°
Gouge Hardness: >9H
Scratch Hardness: 5B
Adhesion: 4A

Rubber
Contact angle: 162°
Hysteresis: 35°
Adhesion: 4A

### Example 3

In this example, a hydrophobic coating was formed on the surface of a glass substrate and a rubber substrate as described below. The mixture applied to the surface of the substrate included two polymers, a hydroxy terminated vinylsiloxane polymer (the linking agent), and a hydrosiloxane polymer for forming cross-links between the polymer strands formed by the lining agent. The mixture also included the chemical modifying reagent vinyltriacetoxysilane. The polymer strands formed by the linking agent were cross-linked via an addition cross-linking reaction catalysed by a platinum catalyst.

The following were mixed together:

| | |
|---|---|
| 0.25 g vinylsiloxane polymer (hydroxy terminated) | CAS [67923-19-7] |
| 0.25 g hydrosiloxane polymer | CAS [68037-59-2] |
| 0.36 g vinyltriacetoxysilane | CAS [4130-08-9] |

1 drop of platinum-divinyltetramethyldisiloxane
complex, 3-3.5% platinum concentration
0.12 g Aerosil silica powder, and
˜25 ml of hexane

The mixture was mixed well and vibrated in an ultrasonic bath for 15 to 30 minutes to disperse the particles and form a uniform mixture. Vibration frequencies of about 40 kHz were used.
The mixture was removed from the ultrasonic bath.
Without allowing the mixture to settle, drops of the mixture were deposited onto the surface of the substrate by spray coating.
The coated substrate was allowed to cure at room temperature for 1-2 days.

The contact angle and hysteresis of water on the coated surfaces, the adhesion of the coatings, and the hardness of the coating on the glass substrate, were:

Glass
Contact angle: 164°
Hysteresis: 18°
Gouge Hardness: >9H
Scratch Hardness: HB
Adhesion: 5A

Rubber
Contact angle: 151°
Hysteresis: 111°
Adhesion: 5A

### Example 4

In this example, a hydrophobic coating was formed on the surface of a glass substrate and a rubber substrate as described below. The linking agent was vinylsiloxane polymer (hydroxy terminated). The polymer strands formed by the linking agent were cross-linked via an addition cross-linking reaction catalysed by a platinum catalyst.

The following were mixed together:

| | |
|---|---|
| 0.25 g vinylsiloxane polymer | CAS [67923-19-7] |
| (hydroxy terminated) | |
| 0.25 g hydrosiloxane polymer | CAS [68037-59-2] |
| 0.36 g methyltriacetoxysilane | CAS [4253-34-3] |

1 drop of platinum-
divinyltetramethyldisiloxane
complex, 3-3.5% platinum concentration
0.12 g Aerosil silica powder, and
˜25 ml of hexane

The mixture was mixed well and vibrated in an ultrasonic bath for 15 to 30 minutes to disperse the particles and form a uniform mixture. Vibration frequencies of about 40 kHz were used.
The mixture was removed from the ultrasonic bath.
Without allowing the mixture to settle, drops of the mixture were deposited onto the surface of the substrate by spray coating.
The coated substrate was cured at room temperature for 1-2 days.

The contact angle and hysteresis of water on the coated surfaces, the adhesion of the coatings, and the hardness of the coating on the glass substrate, were:

Glass
Contact angle: 163°
Hysteresis: 94°
Gouge Hardness: >9H
Scratch Hardness: HB
Adhesion: 5A

Rubber
Contact angle: 161°
Hysteresis: 115°
Adhesion: 5A

### Example 5

In this example, a hydrophobic coating was formed on the surface of a glass substrate and a rubber substrate as described below. The polymer strands were cross-linked via an addition cross-lining reaction catalysed by a platinum catalyst.

The following were mixed together:

| | |
|---|---|
| 0.25 g vinylbutadiene-siloxane | CAS [72905-90-9] |
| polymer (50% in toluene) | |
| 0.25 g hydrosiloxane polymer | CAS [68037-59-2] |
| 0.36 g methyltriacetoxysilane | CAS [4253-34-3] |

1 drop of platinum-
divinyltetramethyldisiloxane
complex, 3-3.5% platinum concentration
0.12 g Aerosil silica powder, and
˜25 ml of hexane

The mixture was mixed well and vibrated in an ultrasonic bath for 15 to 30 minutes to disperse the particles and form a uniform mixture. Vibration frequencies of about 40 kHz were used.
The mixture was removed from the ultrasonic bath.
Without allowing the mixture to settle, drops of the mixture were deposited onto the surface of the substrate by spray coating.
The coated substrate was cured at room temperature for 1-2 days.

The contact angle and hysteresis of water on the coated surfaces, the adhesion of the coatings, and the hardness of the coating on the glass substrate, were:

Glass
Contact angle: 164°
Hysteresis: 95°
Gouge Hardness: >9H
Scratch Hardness: 8B
Adhesion: 5A

Rubber
Contact angle: 147°
Hysteresis: 112°
Adhesion: 0A

### Example 6

In this example, a hydrophobic coating was formed on the surface of a glass substrate as described below. The polymer strands were cross-linked via a condensation cross-linking reaction catalysed by a tin catalyst.

A coating composition comprising the following components was prepared as described below:
10 g methyltrimethoxysilane
1 g polydimethylsiloxane (hydroxy terminated)
0.01-0.1 g dibutyltin dilaurate
0.1-1 g octyltriethoxysilane
0.01-0.2 g 3-aminopropyltriethoxysilane
1 g black pigment (iron oxide)
0.1 g Aerosil silica powder
20 mL toluene

A mixture of methyltrimethoxysilane, polydimethylsiloxane, dibutyltin dilaurate and toluene was stirred at 60° C. for 3 hours.
The resultant solution was then blended with octyltriethoxysilane (OTES) and 3-aminopropyltriethoxysilane. This mixture was then added to a silica/pigment mixture to form the coating composition in the form of a slurry.

The coating composition was applied to the glass substrate by brushing, and then cured at room temperature for at least 12 hours.

The contact angle and hysteresis of water on the coated surface, and the hardness and adhesion of the coating, were:

Glass
Contact angle: 170°
Hysteresis: 49°
Gouge Hardness: >9H
Scratch Hardness: >9H
Adhesion: 5A

### Example 7

In this example, a hydrophobic coating was formed on the surface of a concrete substrate as described below. The polymer strands were cross-linked via a condensation cross-linking reaction catalysed by a tin catalyst.

A coating composition comprising the following components was prepared as described below:
10 g methyltrimethoxysilane
1 g polydimethylsiloxane (hydroxy terminated)
0.01-0.1 g dibutyltin dilaurate
0.1-1 g octyltiethoxysilane
0.01-0.2 g 3-aminopropyltriethoxysilane
50 g grey cement
15 g sand
20 mL toluene

A mixture of methyltrimethoxysilane, polydimethylsiloxane, dibutyltin dilaurate and toluene was stirred at 60° C. for 3 hours.

The resultant solution was then blended with octyltriethoxysilane (OTES) and 3-aminopropyltriethoxysilane. This mixture was then added to a cement/sand mixture (prepared by mixing the grey cement and sand) to form the coating composition in the form of a slurry.

The coating composition was applied to the concrete substrate by brushing, and then cured at room temperature for at least 12 hours.

The contact angle and hysteresis of water on the coated surface, and the hardness and adhesion of the coating, were:
Contact angle: 169°
Hysteresis: 47°
Gouge Hardness: >9H
Scratch Hardness: >9H
Adhesion: 5A

### Example 8

In this example, a hydrophobic coating was formed on a concrete substrate as described below. The polymer strands were cross-linked via a condensation cross-linking reaction catalysed by a tin catalyst.

A coating composition comprising the following components was prepared as described below:
10 g methyltrimethoxysilane
1 g polydimethylsiloxane (hydroxy terminated)
1 g (3-glycidoxypropyl)trimethoxysilane
0.01-1.1 g dibutyltin dilaurate
0.1-1 g octyltriethoxysilane
0.01-0.2 g 3-aminopropyltriethoxysilane
50 g grey cement
15 g sand
20 mL toluene

A mixture of methyltrimethoxysilane, polydimethylsiloxane, (3-glycidoxypropyl)trimethoxysilane, dibutyltin dilaurate and toluene was stirred at 60° C. for 3 hours.
The resultant solution was then blended with octyltriethoxysilane (OTES) and 3-aminopropyltriethoxysilane. This mixture was then added to a cement/sand mixture to form the coating composition in the form of a slurry.

The coating composition was applied to the concrete substrate by brushing, and then cured at room temperature for at least 12 hours.

The contact angle and hysteresis of water on the coated surface, and the hardness and adhesion of the coating, were:
Contact angle: 169°
Hysteresis: 47°
Gouge Hardness: >9H
Scratch Hardness: >9H
Adhesion: 5A

### Example 9

In this example, a hydrophobic coating was formed on the surface of a concrete substrate as described below. The polymer strands were cross-linked via a condensation cross-linking reaction catalysed by a tin catalyst.

A coating composition comprising the following components was prepared as described below:
10 g methyltrimethoxysilane
1 g polydimethylsiloxane (hydroxy terminated)
0.01-0.1 g dibutyltin dilaurate
0.1-1 g octyltriethoxysilane
0.01-0.2 g 3-aminopropyltriethoxysilane
50 g gypsum
20 mL toluene

A mixture of methyltrimethoxysilane, polydimethylsiloxane, dibutyltin dilaurate and toluene was stirred at 60° C. for 3 hours.

The resultant solution was then blended with octyltriethoxysilane (OTES) and 3-aminopropyltriethoxysilane. This mixture (prepared by mixing the grey cement and sand) was then added to gypsum to form the coating composition in form of a slurry.

The coating composition was applied to the concrete substrate by brushing, and then cured at room temperature for at least 12 hours.

The contact angle and hysteresis of water on the coated surface, and the hardness and adhesion of the coating, were:
Contact angle: 169°
Hysteresis: 45°
Gouge Hardness: >9H
Scratch Hardness: >9H
Adhesion: 5A

### Example 10

In this example, a hydrophobic coating was formed on the surface of a concrete substrate as described below. The polymer strands were cross-linked via a condensation cross-linking reaction catalysed by a tin catalyst.

A coating composition comprising the following components was prepared as described below:
10 g methyltrimethoxysilane
1 g polydimethylsiloxane (hydroxy terminated)
1 g (3-glycidoxypropyl)trhnethoxysilane
0.01-0.1 g dibutyltin dilaurate
0.1-1 g octyltriethoxysilane
0.01-0.2 g 3-aminopropyltriethoxysilane
50 g gypsum
20 mL toluene

A mixture of methyltrimethoxysilane, polydimethylsiloxane, (3-glycidoxypropyl)trimethoxysilane, dibutyltin dilaurate and toluene was stirred at 60° C. for 3 hours.

The resultant solution was then blended with octyltriethoxysilane (OTES) and 3-aminopropyltriethoxysilane. This mixture was then added to gypsum to form the coating composition in the form of a slurry.

The coating composition was applied to the concrete substrate by brushing, and then cured at room temperature for at least 12 hours.

The contact angle and hysteresis of water on the coated surface, and the hardness and adhesion of the coating, were:
Contact angle: 169°
Hysteresis: 45°
Gouge Hardness: >9H
Scratch Hardness: >9H
Adhesion: 5A

The contact angle of water on the coatings prepared in Example 1 was similar to the contact angle of water on the coatings prepared in the Comparative Example. Accordingly, the cross-linking of the polymer strands did not have a detrimental effect on the hydrophobicity of the coatings prepared in Example 1.

The method of the present invention can be used to prepare hydrophobic coatings on the surface of a variety of solid substrates including metals, alloys, glasses, papers, ceramics, polymers, composites and other materials.

The present inventors have found that cross-linking the polymers strands via covalent bonds strengthens the network of chemical bonds in the hydrophobic coating, which enhances the durability of the hydrophobic coating formed by the method of the present invention, as is shown by the results of the gouge and scratch hardness tests.

Coatings formed by the method of the present invention have a wide variety of uses. The method of the present invention can be used to from coatings on the surface of a substrate to inhibit corrosion of the substrate. The method can be used to coat the surface of a substrate to inhibit the formation of crystallisation centres, for example, in water pipelines, closed heat exchanges, tubular boilers, chillers and refiigerators, which use water, brine solutions, inorganic, alkalies or other electrolytes. The method can also be used to from coatings on surfaces to inhibit icing of the surface.

The coatings formed by the method of the present invention can also be used to provide anti-icing, anti-fouling and anti-corrosion coatings for maritime and other waterways vessels.

The coatings can also be used to improve the resistance of surfaces to colonisation by biological organisms such as microflora. The coatings can also be used to provide water resistance or water proofing to surfaces.

The coatings can also be used to reduce drag for water craft.

In the claims which follow and in the preceding description of the invention, except where the context requires otherwise due to express language or necessary implication, the word “comprising” and grammatical variations thereof is used in an inclusive sense, i.e. the features specified may be associated with further features in various embodiments of the invention.

1. A method for forming a hydrophobic coating on the surface of a substrate, the method comprising the steps of:
(a) applying a mixture comprising a particulate material and a linking agent to the surface to form a coating on the surface, wherein the linking agent is capable of forming a polymer strand linking two or more particles of the particulate material and capable of forming a polymer strand linking the surface and one or more particles of the particulate material;
(b) exposing the coating to conditions such that the linking agent forms polymer strands linking two or more particles of the particulate material, and forms polymer strands linking the surface and one or more particles of the particulate material, thereby linking the particles together and to the surface by polymer strands; and
(c) exposing the coating to conditions effective to cause at least some of the polymer strands linking two or more particles or linking the surface and one or more particles, to cross-link with other polymer strands linking two or more particles or linking the surface and one or more particles.

2. A method for forming a hydrophobic coating on the surface of a substrate, the method comprising the steps of:
(a) applying a mixture comprising a particulate material, a linking agent and a peroxide to the surface to form a coating on the surface, wherein the linking agent is capable of forming a polymer strand linking two or more particles of the particulate material and capable of forming a polymer strand linking the surface and one or more particles of the particulate material, and wherein the peroxide is capable of causing a peroxide catalysed cross-linking reaction between polymer strands formed by the linking agent;
(b) exposing the coating to conditions such that the linking agent forms polymer strands linking two or more particles of the particulate material, and forms polymer strands linking the surface and one or more particles of the particulate material, thereby linking the particles together and to the surface by polymer strands; and
(c) exposing the coating to conditions effective to cause a peroxide catalysed cross-linking reaction between at least some of the polymer strands linking two or more particles or linking the surface and one or more particles.

3. A method according to claim 2 wherein the peroxide is selected from the group consisting of dicumyl peroxide, 2,4-dichlorobenzoyl peroxide, benzoyl peroxide, and mixtures thereof.

4. A method for forming a hydrophobic coating on the surface of a substrate, the method comprising the steps of:
(a) applying a mixture comprising a particulate material, a linking agent and a platinum catalyst to the surface to form a coating on the surface, wherein the linking agent is capable of forming a polymer strand linking two or more particles of the particulate material and capable of forming a polymer strand linking the surface and one or more particles of the particulate material, and wherein the platinum catalyst is capable of catalysing a vinyl addition cross-linking reaction to cross-link polymer strands formed by the linking agent;
(b) exposing the coating to conditions such that the linking agent forms polymer strands linking two or more particles of the particulate material, and forms polymer strands linking the surface and one or more particles of the particulate material, thereby linking the particles together and to the surface by polymer strands; and
(c) exposing the coating to conditions effective to cause a platinum catalysed vinyl addition cross-linking reaction to cross-link at least some of the polymer strands linking two or more particles or linking the surface and one or more particles.

5. A method for forming a hydrophobic coating on the surface of a substrate, the method comprising the steps of:
(a) applying a mixture comprising a particulate material, a linking agent, a polymer having terminal vinyl groups and a platinum catalyst to the surface to form a coating on the surface, wherein the linking agent is capable of forming a polymer strand linking two or more particles of the particulate material and capable of forming a polymer strand linking the surface and one or more particles of the particulate material, and wherein the platinum catalyst is capable of catalysing a vinyl addition reaction between the polymer having terminal vinyl groups and polymer strands formed by the linking agent;
(b) exposing the coating to conditions such that the linking agent forms polymer strands linking two or more particles of the particulate material, and forms polymer strands linking the surface and one or more particles of the particulate material, thereby linking the particles together and to the surface by polymer strands; and
(c) exposing the coating to conditions effective to cause a vinyl addition reaction between the polymer having terminal vinyl groups and at least some of the polymer strands linking two or more particles or linking the surface and one or more particles.

6. A method according to claim 5 wherein the polymer having terminal vinyl groups is selected from the group consisting of vinyl terminated polydimethylsiloxane, vinyl terminated diphenylsiloxane-dimethylsiloxane copolymer, vinyl terminated trifluoropropylmethylsiloxane-dimethylsiloxane copolymer, vinylmethyloxysiloxane homopolymer and mixtures thereof.

7. A method according to claim 4 wherein the platinum catalyst is selected from the group consisting of platinum divinyl complexes, platinum cyclovinyl complexes, and mixtures thereof.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A method according to claim 5 wherein the platinum catalyst is selected from the group consisting of platinum divinyl complexes, platinum cyclovinyl complexes, and mixtures thereof.

37. A method for forming a hydrophobic coating on the surface of a substrate, the method comprising the steps of:
(a) applying a mixture comprising a particulate material, a linking agent, and a tin or zinc catalyst to the surface to form a coating on the surface, wherein the linking agent is capable of forming a polymer strand linking two or more particles of the particulate material and capable of forming a polymer strand linking the surface and one or more particles of the particulate material, and wherein the catalyst is capable of catalysing a condensation cross-linking reaction to cross-link polymer strands formed by the linking agent;
(b) exposing the coating to conditions such that the linking agent forms polymer strands linking two or more particles of the particulate material, and forms polymer strands linking the surface and one or more particles of the particulate material, thereby linking the particles together and to the surface by polymer strands; and
(c) exposing the coating to conditions effective to cause a condensation cross-linking reaction to cross-link at least some of the polymer strands linking two or more particles or linking the surface and one or more particles.

38. A method according to claim 37 wherein the catalyst is dibutyltin dilaurate or zinc octoate.

39. A method according to claim 37 wherein the mixture further comprises a trifunctional alkylsilane.

40. A method according to claim 1 wherein the linking agent is a polymer or mixture of polymers selected from the group consisting of hydroxy terminated vinylsiloxane polymer, hydroxy terminated polydimethylsiloxane, hydroxy terminated polydiphenylsiloxane, hydroxy terminated polyphenylmethylsiloxane, methylhydrosiloxane (and copolymers with dimethylsiloxane), vinylmethoxysiloxane homopolymer, polytrifluoropropylmethylsiloxane (silanol terminated), vinylmethylsiloxane-dimethylsiloxane copolymer (silanol terminated) and vinylmethylsiloxanes.

41. A method according to claim 1 wherein the linking agent is a polymer or mixture of polymers selected from the group consisting of modified polystyrene, polyethylenes, fluorinated polymers, and triethoxysilyl modified poly-1,2-butadiene.

42. A method according to claim 1 wherein the linking agent is a bifuntional or trifunctional alkylsilane.

43. A method according to claim 1 wherein the mixture in step (a) further comprises a chemical modifying reagent capable of reacting with at least some of the particles of the particulate material to enhance the chemical hydrophobicity of the particles.

44. A method according to claim 43 wherein the chemical modifying reagent is a compound containing one or more condensation cure groups and one or more hydrophobic groups.

45. A method according to claim 44 wherein the chemical modifying reagent is a compound of the formula SiR¹(OR²)₃, where R¹ is a hydrophobic group, and each R² is independently selected and is methyl, ethyl or acetyl.

46. A method accordingly to claim 1 wherein the particulate material is selected from the group consisting of silica particles, particles of cementitious material, metal particles, glass particles, particles of a metal oxide, and mixtures thereof.

47. A method according to claim 46 wherein the metal oxide is titanium oxide, aluminium oxide, zirconium oxide or zinc oxide.

48. A method according to claim 1 wherein the particulate material comprises silica particles.

49. A method according to claim 48 wherein the silica particles are flame hydrolysed silica particles.

50. A method according to claim 1 wherein the particles of the particulate material have an average particle size of from 1 nm to 500 μm.

51. A method according to claim 50 wherein the particles of the particulate material have an average particle size in the range of from 1 nm to 100 μm.

52. A method according to claim 51 wherein the particles of the particulate material have an average particle size in the range of from 1 nm to 50 nm.

53. A method according to claim 1 wherein step (b) comprises heating the coating to a temperature and for a period of time effective for the linking agent to form polymer strands linking two or more particles of the particulate material, and to form polymer strands linking the surface and one or more particles of the particulate material, thereby linking the particles together and to the surface by polymer strands.

54. A method according to claim 1 wherein step (c) comprises heating the coating to a temperature of up to 150° C. for a period of time effective for at least some of the polymer strands to become cross-linked.

55. A method according to claim 1 wherein steps (b) and (c) are carried out simultaneously.

56. A method according to claim 1 wherein step (b) is carried out prior to step (c).

57. A method according to claim 1 wherein the contact angle of water on the coating formed by the method is at least 150° C.

58. A method according to claim 1 wherein the contact angle of water on the coating formed by the method is at least 160° C.

59. A hydrophobic coating produced by the method according to claim 1.

60. An object having a surface at least a portion of which is coated with a hydrophobic coating formed by the method according to claim 1.

61. A hydrophobic coating comprising particles of a particulate material bound together and to the surface by polymer strands, wherein at least some of the polymer strands are cross-linked.

62. A hydrophobic coating according to claim 61 wherein the particulate material is selected from the group consisting of silica particles, particles of cementitious material, metal particles, glass particles, particles of a metal oxide, and mixtures thereof.

63. A hydrophobic coating according to claim 61 wherein the particulate material comprises particles having an average particle size of from 1 nm to 500 μm.

64. A hydrophobic coating comprising particles of a particulate material bound together and to the surface by polymer strands, with at least some of the polymer strands being cross-linked, wherein the coating is formed by the method defined by claim 1.
